(19) United States
(12) Patent Application Publication
(10) Pub. No.: US 2008/0158397 A1
(43) Pub. Date: Jul. 3, 2008

(54) SOLID-STATE IMAGING APPARATUS AND SIGNAL PROCESSING METHOD

(76) Inventor: Toshiaki Hayakawa, Kurokawa-gun (JP)

Correspondence Address: BIRCH STEWART KOLASCH & BIRCH, PO BOX 747, FALLS CHURCH, VA, 22040-0747, US

(21) Appl. No.: 11/952,249

(22) Filed: Dec. 7, 2007

(30) Foreign Application Priority Data
Dec. 11, 2006 (JP) 2006-333181

(51) Int. Cl. H04N 5/335

(52) U.S. Cl. 348/274

(57) ABSTRACT

A pixel section is divided into a plurality of segment regions 10a, 10b, 10c, and 10d along one direction. The plurality of segment regions are formed so that signal charges generated from the respective segment regions are converted into image data in accordance with predetermined conversion conditions, segment regions at least partially overlaps each other along a direction perpendicular to the one direction. Pixels signals output from the overlapping portions R1, R2, and R3 are compared with each other. The pixel signals are corrected so that offset differences between the overlapping portions and gain ratio between the overlapping portions, which are caused when the signal charges are converted into the pixel signals, are equal to each other.

### CROSS-REFERENCE TO RELATED APPLICATIONS

This application is based upon and claims the benefit of priority from the Japanese Patent Application No. 2006-333181 filed on Dec. 11, 2006, the entire contents of which are incorporated herein by reference.

### BACKGROUND OF THE INVENTION

1. Technical Field

The invention relates to a solid-state imaging apparatus for imaging a two-dimensional image, and to a signal processing method for processing signals of the solid-state imaging apparatus.

2. Description of the Related Art

In a solid-state imaging apparatus mounted on digital cameras or the like to capture a two-dimensional image, the number of photoelectric conversion elements (such as photodiodes), mounted on a pixel section has been gradually increased in order to make it possible to capture an image with a higher resolution.

In a solid-state imaging device having a basic configuration, a large number of signal charges (signals corresponding to pixels) detected by photoelectric conversion elements are sequentially read out as serial signals from one output terminal. Accordingly, as the number of photoelectric conversion elements increases, the time taken to read out the entire signal charges for one frame increases, or it may be required to read out signals at higher speed. When the reading time increases, it is difficult to perform the high-speed capturing. Thus, the number of obtained frames per a unit time decreases. Also, in order to perform a high-speed signal reading, it is required to change a circuit configuration, which inevitably increases the cost. Even if the circuit configuration is changed, there is a limit in speeding up the signal reading.

It has been attempted that a pixel section is divided into a plurality of regions, and that signals are output in parallel from a plurality of output terminals that are provided independently for the respective regions. Since this technique greatly reduces the number of photoelectric conversion elements included in each of the segment regions as compared with the total number of the photoelectric conversion elements, it is possible to reduce the time taken to read out the entire signal charges for one frame.

However, in the case of using this technique, the signals are output from different output terminals using circuits (CCDs for transfer and output amplifiers) that are provided independently for the respective segment regions. Accordingly, influence of characteristics variation in the circuits appears on the output signals. Specifically, the influence such as an offset variation or a gain variation, which may be caused by the characteristics variation in the circuits, appears on the output signals. For this reason, when a captured two-dimensional image is seen, there may be a remarkable difference such that one can recognize boundaries, particularly, at boundaries between the plurality of segment regions. Therefore, the quality of obtained images is deteriorated.

JP 2004-350265 A (corresponding to US 2004/0212707 A) describes a technique of controlling a CMOS-type solid-state imaging device in which the pixel section is divided into the plurality of regions, while proposing countermeasure against deterioration of the image quality. Specifically, the boundaries between the segment regions are formed in a zigzag manner, rather than extending in a linear fashion. With such a configuration, the boundary lines are obscurely seen due to the visual characteristics of the human eyes. A difference in brightness or the like between regions adjacent to the boundary is smoothed. Accordingly, the boundaries between the segment regions are inconspicuous.

However, when the pixel section is divided into the segment regions so that the boundaries are formed in the zigzag manner, the boundary lines are obscurely seen, which inevitably deteriorates resolution. Then, JP 2004-350265 A further describes performing a filtering process to correct the characteristics difference between the segment regions.

JP 2005-64760 A pays attention to the fact that when a pixel section is divided into a plurality of regions, the characteristic difference between the regions has some relation with a charge mixture amount corresponding to an amount of signal charges that remain on the segment regions after the signal charges are transferred through a CCD (Charge Coupled Device). Then, JP 2005-64760 A describes correcting signals based on the charge mixture amount which is detected in each segment region, so as to make the boundary lines invisible.

In the technique disclosed in JP 2004-350265 A, to perform the filtering process, a plurality of output circuits have to detect the same signal charges on the boundaries between the plurality of regions. Also, two output circuits have to read out the signal charges obtained by one exposure step in a redundant manner, or two output circuits have to read out the signal charges obtained by two exposure steps in an alternating manner. However, the redundant reading of the signal charges needs to be performed in a nondestructive manner, which inevitably deteriorates the detection sensitivity. Meanwhile, in the case of the two-exposure reading, it is difficult to perform an accurate correction because the exposure characteristic may change with time between the first exposure step and the second exposure step.

In the technique disclosed in JP 2005-64760 A, since it is difficult to detect a difference in circuit characteristics such as a gain ratio among the regions, it is difficult to accurately correct the gain ratio. Accordingly, although the boundary lines are made invisible, it is difficult to effectively suppress the deterioration in resolution caused when the boundaries are formed in the zigzag manner, that is, the deterioration in image quality is not suppressed.

### SUMMARY OF THE INVENTION

The invention provides a solid-state imaging apparatus and a signal processing method in which when a pixel section is divided into a plurality of regions and when signals are read in parallel using output terminals that are provided independently for the respective regions, it is possible to accurately correct differences in characteristics among the segment regions without requiring to perform redundant reading of signals at the same pixel position or to perform a plurality of exposure steps.

(1) According to an aspect of the invention, a solid-state imaging apparatus includes a solid-state imaging device and a signal processing section. The solid-state imaging device includes a pixel section and a charge transfer section. The pixel section has a plurality of two-dimensionally arranged photoelectric conversion elements that generate signal charges in accordance with incident light. The charge transfer section receives the signal charges from the pixel section and transfers the received signal charges in a predetermined direction. The signal processing section converts the signal charges output from the solid-state imaging device into pixel signals to generate image data. The pixel section is divided, along one direction, into a plurality of segment regions. The signal processing section obtains the signal charges generated in the respective segment regions from different positions in the charge transfer section through different output sections and converts the obtained signal charges into the image data in accordance with predetermined conversion conditions. The plurality of segment regions are formed so that the segment regions at least partially overlap each other along a direction perpendicular to the one direction. The signal processing section has a function of correcting the pixel signals. The function compares the pixel signals of a plurality of overlapping portions where the segment regions overlap each other and makes the conversion conditions for the respective segment regions equivalent to each other.

With this solid-state imaging apparatus, the conversion conditions for converting the signal charges into the pixel signals are set to be equivalent to each other based on the pixel signals of the overlapping portion, which overlap each other in the perpendicular direction, of the segment regions. Therefore, even when the pixel section is divided and the signal charges are output from a plurality of amplifiers, it is possible to make the boundary lines between the segment regions of the image data inconspicuous, that is, to make the boundary line in the overlapping portion inconspicuous. Accordingly, it is possible to prevent deterioration in the image quality.

For example, a difference in characteristics such as offset or gain occurs among the signals of the plurality of segment regions due to variation in electrical characteristics between an output amplifier connected to a first output section and an output amplifier connected to a second amplifier. However, the boundaries among the plurality of region are not linear, but the boundaries are formed in a zigzag manner. Therefore, the boundaries become inconspicuous under the visual characteristics of the human eyes. Also, the difference in characteristics such as offset or gain occurring among the signals of the plurality of segment regions can be accurately corrected by the use of the amount of correction. Therefore, even when the boundaries are formed in the zigzag manner, it is possible to prevent the deterioration in the image quality.

(2) In the solid-state imaging apparatus of (1), the signal processing section may correct the pixel signals so that (i) an offset difference in each overlapping portion, which is caused when the signal charges output from each overlapping portion between the corresponding segment regions are converted into the pixel signals, is substantially equal to zero, and (ii) a gain ratio in each overlapping portion, which is caused when the signal charges output from each overlapping portion between the corresponding segment regions are converted into the pixel signals, are substantially equal to 1.

With this solid-state imaging apparatus, although the signals output from the respective output sections are converted into the pixel signals using amplifiers having different characteristics from each other, the correction is performed so that (i) the offset difference in each overlapping portion is substantially equal to zero and (ii) the gain ratios in each overlapping portion is substantially equal to 1. Therefore, it is possible to keep the conversion conditions regular, and also it is possible to make the boundary lines of the segment regions inconspicuous.

(3) In the solid-state imaging apparatus of (2), each offset difference may be a value based on a difference between (i) a first average value of the pixel signals of the whole overlapping portion of one of the segment regions within an optical black region where extraneous light is restricted to be incident and (ii) a second average value of the pixel signals of the whole overlapping portion of another of the segment regions.

With this solid-state imaging apparatus, the difference between the first average value of the whole overlapping portion of the one of the segment regions within the optical black region and the second average value of the whole overlapping portion of the other of the segment regions is set as the offset difference. Thus, it is possible to perform an accurate correction.

(4) In the solid-state imaging apparatus of (2) or (3), each gain ratio may be a value based on a ratio of (i) a first integration value of the pixel signals of the whole overlapping portion of one of the segment regions to (ii) a second integration value of the pixel signals of the whole overlapping portion of another of the segment regions.

With this solid-state imaging apparatus, the ratio of integration values of the pixel signals of the overlapping portions of the respective segment regions are set as the gain ratio. Thus, it is possible to perform an accurate correction.

(5) In the solid-state imaging apparatus of any of (1) to (4), the pixel section may be divided into the segment regions so as to periodically form the overlapping portions between the segment regions.

With this solid-state imaging apparatus, the overlapping portions are formed periodically. Thus, it is possible to make an image pattern that varies with a period longer than the period of the overlapping portions, well inconspicuous.

(6) According to another aspect of the invention, a solid-state imaging apparatus includes a solid-state imaging device. The solid-state imaging device includes a pixel section and a charge transfer section. The pixel section has a plurality of two-dimensionally arranged photoelectric conversion elements that generate signal charges in accordance with incident light. The charge transfer section receives the signal charges from the pixel section and transfers the received signal charges in a predetermined direction. The pixel section is divided, along one direction, into a plurality of segment regions. The plurality of segment regions are formed so that the segment regions at least partially overlap each other along a direction perpendicular to the one direction. A signal processing method for use in the solid-state imaging apparatus includes: obtaining the signal charges generated in the respective segment regions from different positions in the charge transfer section through different output sections; converting the signal charges obtained from the solid-state imaging device into pixel signals; comparing the pixel signals of a plurality of overlapping portions where the segment regions overlap each other; and correcting the pixel signals of the respective segment regions so that (i) an offset difference in each overlapping portion, which is caused when the signal charges output from each overlapping portion between the corresponding segment regions are converted into the pixel signals, is substantially equal to zero, and (ii) a gain ratio in each overlapping portion, which is caused when the signal charges output from each overlapping portion between the corresponding segment regions are converted into the pixel signals, are substantially equal to 1.

With this signal processing method, the conversion conditions for converting the signal charges into the pixel signals are set to be equivalent to each other based on the pixel signals of the overlapping portions of the segment regions. Therefore, even when the pixel section is divided and the signal charges are output from a plurality of amplifiers, it is possible to make the boundary lines between the segment regions of the image data inconspicuous, that is, to make the boundary line in the overlapping portion inconspicuous. Accordingly, it is possible to prevent deterioration in the image quality.

According to the solid-state imaging apparatus and the signal processing method described above, the pixel section is divided into the plurality of segment regions along the one direction, the plurality of segment regions are formed so that the segment regions at least partially overlap each other along the direction perpendicular to the one direction, and the correction process is performed for the pixel signals by comparing the pixel signals of the plurality of overlapping portions of the segment regions and by making the conversion conditions for the respective segment regions equivalent to each other. Thereby, even when the pixel section is divided into the plurality of regions and signals are read out in parallel using output terminals that are provided independently for the respective segment regions, it is possible to accurately correct differences in characteristics among the segment regions without requiring to perform the redundant reading of signals at the same pixel position or to perform a plurality of exposure steps. Consequently, it is possible to prevent deterioration in the quality of output image data.

### BRIEF DESCRIPTION OF THE DRAWINGS

FIG. 1 is a schematic block diagram illustrating the configuration of a solid-state imaging apparatus according to an embodiment of the invention.

FIG. 2 is a partially enlarged plan view illustrating a specific example of dividing of a pixel section of the solid-state imaging apparatus shown in FIG. 1 into segment regions.

FIG. 3 is a partially enlarged plan view illustrating the example of the dividing of the pixel section of the solid-state imaging apparatus shown in FIG. 2 into the segment regions and a specific example of a target process region.

FIG. 4 is a flowchart illustrating main procedures of a offset correction process and a gain correction process.

FIG. 5 is a flowchart illustrating specific procedures of calculating an offset difference.

FIG. 6 is a flowchart illustrating specific procedures of calculating a gain ratio.

FIG. 7 is a plan view illustrating the configuration of main portions of a simplified solid-state imaging device.

FIG. 8 is an explanatory view illustrating a specific control example in the case of reading out signal charges from a solid-state imaging device having the configuration shown in FIG. 7.

FIG. 9 is a plan view illustrating a specific example of the detailed configuration in the vicinity of a horizontal charge transfer section of the solid-state imaging device shown in FIG. 7.

FIG. 10 is a time chart illustrating a specific example of changes in positions of respective signal charges in the horizontal charge transfer section shown in FIG. 9.

FIG. 11 is an explanatory view illustrating another form of dividing of the pixel section of the solid-state image device into segment regions.

### DETAILED DESCRIPTION OF EMBODIMENT(S) OF THE INVENTION

Embodiments of a solid-state imaging apparatus and a signal processing method according to the invention will be described in detail with reference to the drawings.

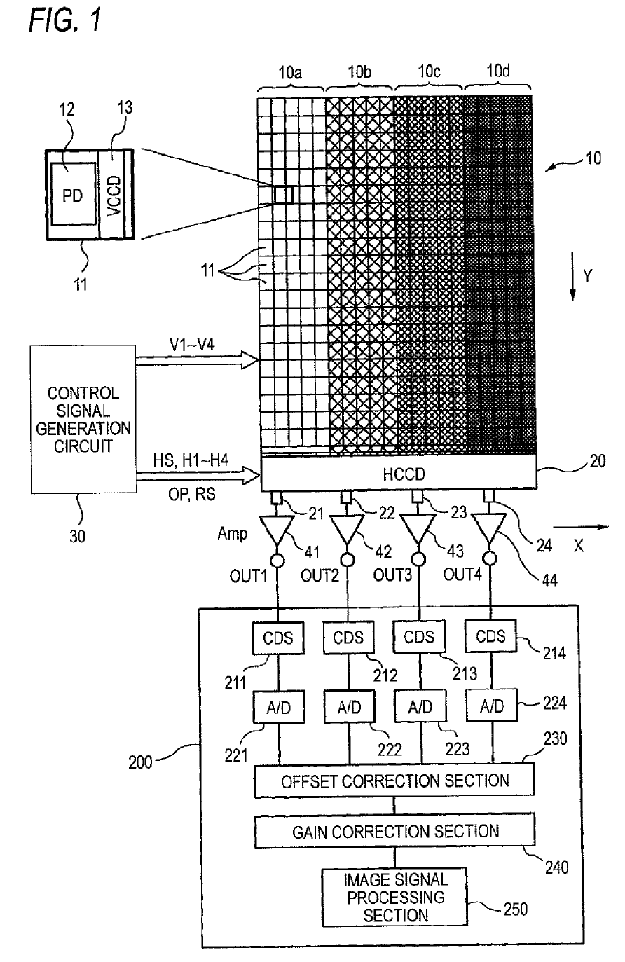

FIG. 1 is a schematic block diagram illustrating the configuration of a solid-state imaging apparatus.

The solid-state imaging apparatus 100 shown in FIG. 1 includes a solid-state imaging device that captures a two-dimensional image, a control signal generation circuit 30 that controls the solid-state imaging device, and a signal processing section 200 that processes signals of respective pixels output from the solid-state imaging device. A pixel section 10 of the solid-state device has a large number of imaging cells 11 arranged at the same intervals in a row direction (arrow X direction) and a column direction (arrow Y direction) so as to capture the two-dimensional image. Each imaging cell 11 has a photodiode (PD) that is a photoelectric conversion element 12. Incident light incoming from a photographic subject enters a light receiving surface of the photoelectric conversion element 12 in a direction perpendicular to the paper of FIG. 1 through a predetermined optical system (lens and optical filter; not shown). The photoelectric conversion element 12 generates signal charges in response to an intensity of the incident light and an exposure time.

A vertical charge transfer section (VCCD) 13 is provided adjacent to each photoelectric conversion element 12 (FIG. 1 shows a part thereof). Plural columns of the vertical charge transfer sections 13 are provided independently for the respective columns of the imaging cells 11. Each vertical charge transfer section 13 receives accumulated signal charges from the photoelectric conversion elements 12 adjacent thereto. Then, each vertical charge transfer section 13 transfers the received signal charges to a horizontal charge transfer section (HCCD) 20 in the arrow Y direction on a channel, that is, in a vertical direction in FIG. 1. After the signal charges are transferred by the vertical charge transfer sections 13 in the vertical direction to the horizontal charge transfer section 20 that constitutes a CCD, the signal charges are transferred by a transfer operation of the horizontal charge transfer section 20 in the horizontal direction (the arrow X direction an opposite direction thereto), and are output as serial signals one by one.

In the example shown in FIG. 1, in order to make it possible to read out signals at a high speed even in the case where there are a large number of imaging cells 11, the entire pixel section 10 is divided into four parts in the horizontal direction to form four segment regions 10a, 10b, 10c, and 10d. The horizontal charge transfer section 20 has four output branch sections 21, 22, 23, and 24 disposed at four positions different from each other in the horizontal direction. The four output branch sections 21, 22, 23, and 24 are connected respectively to four output amplifiers 41, 42, 43, and 44 that are provided independently from each other.

The signal charges obtained by each imaging cell 11 of the segment region 10a of the pixel section 10 are transferred from the horizontal charge transfer section 20 through the output branch section 21 to the output amplifier 41, the transferred signal charges are amplified by the output amplifier 41, and the amplified signal charges are output to an output terminal OUT1 as voltage signals (pixel signals). Similarly, the signal charges obtained by each imaging cell 11 of the segment region 10b of the pixel section 10 are transferred from the horizontal charge transfer section 20 through the output branch section 22 to the output amplifier 42, the transferred signal charges are amplified by the output amplifier 42, and the amplified signal charges are output to an output terminal OUT2 as voltage signals. The signal charges obtained by each imaging cell 11 of the segment region 10c of the pixel section 10 are transferred from the horizontal charge transfer section 20 through the output branch section 23 to the output amplifier 43, the transferred signal charges are amplified by the output amplifier 43, and the amplified signal charges are output to an output terminal OUT3 as voltage signals. In addition, the signal charges obtained by each imaging cell 11 of the segment region 10d of the pixel section 10 are transferred from the horizontal charge transfer section 20 through the output branch section 24 to the output amplifier 44, the transferred signal charges are amplified by the output amplifier 44, and the amplified signal charges are output to an output terminal OUT4 as voltage signals.

The output terminals OUT1 to OUT4 are connected to input ports of the signal processing section 200, respectively. As shown in FIG. 1, the signal processing section 200 includes low-frequency noise removing sections (CDS) 211 to 214, analog/digital converting sections (AD) 221 to 224, an offset correction section 230, a gain correction section 240, and an image signal processing section 250. The signal processing section 200 has a function of correcting pixel signals (which will be described later).

When the pixel section 10 is divided into the plurality of segment regions 10a to 10d and the detected signal charges are output through paths, for the respective segment regions 10, that are different from each other, level offset and/or a difference in gain is caused among the signal charges of the segment regions 10a, 10b, 10c, and 10d due to the influence of variation in characteristics of the output amplifiers 41 to 44. For this reason, when human sees a captured two-dimensional image, a concentration difference that would be recognized as “boundaries” appears in positions corresponding to boundaries among the respective segment regions 10a, 10b, 10c and 10d. That is, since the boundaries among the segment regions are conspicuous, it is difficult to obtain a high-quality image.

As a countermeasure against it, the signal processing section 200 has the offset correction section 230 and the gain correction section 240. The offset correction section 230 is provided to correct offsets in signal level that are caused due to differences in characteristics of the segment regions 10a, 10b, 10c, and 10d. The gain correction section 240 is provided to correct differences in signal level that are caused due to differences in characteristics of the segment regions 10a, 10b, 10c, and 10d. That is, the offset correction section 230 and the gain correction section 240 are provided to correct the offset differences and the gain ratios among the output amplifiers 41 to 44. Specific operations of the offset correction section 230 and the gain correction section 240 will be described later.

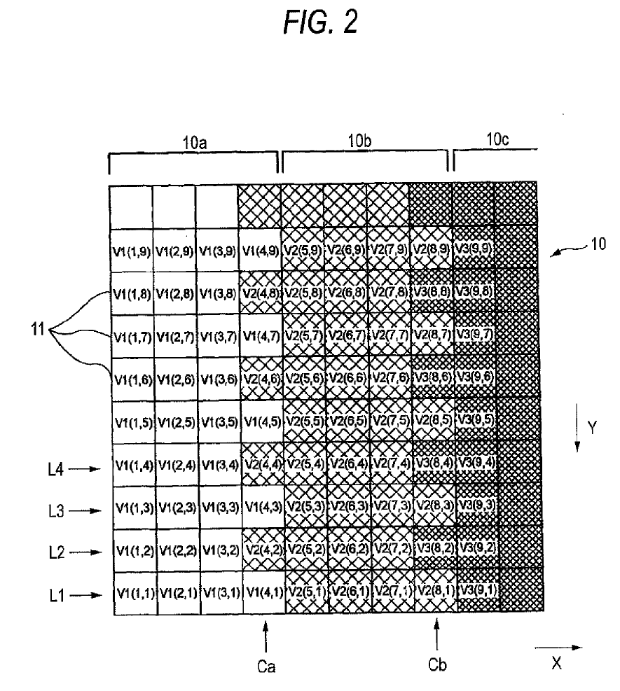

There may be a case where the offset correction and the gain correction are not sufficient as the countermeasure that makes the boundaries among the segment regions inconspicuous. Then, in the solid-state imaging apparatus according to this embodiment, for example, boundaries are formed in a zigzag manner as shown in FIG. 2.

FIG. 2 is a partially enlarged plan view illustrating a specific example of dividing of the pixel section 10 of the solid-state imaging apparatus shown in FIG. 1 into the segment regions. In the example shown in FIG. 2, each boundary is formed so that columns alternately form the boundary between adjacent segment regions, one line by one line. When the boundaries are formed in such a manner, the concentration difference between both sides across the boundary is smoothed with respect to the human eyes. Therefore, the boundaries become inconspicuous.

In FIG. 2, an imaging cell 11 belonging to a first row L1 and to a column Ca is assigned to the segment region 10a, while an imaging cell 11 belonging to a second row L2 and to the column Ca is assigned to the segment region 10b. Similarly, an imaging cell 11 belonging to a third row L3 and to the column Ca is assigned to the segment region 10a, and an imaging cell 11 belonging to a fourth row L4 and to the column Ca is assigned to the segment region 10b. That is, the imaging cells 11 belonging to the column Ca are alternately assigned to the segment region 10a and the segment region 10b one row by one row. Imaging cells 11 belonging to a column Cb are alternately assigned to the segment region 10b and the segment region 10c one row by one row.

In order to form the boundaries in the zigzag manner as shown in FIG. 2, the control signal generation circuit 30 shown in FIG. 1 performs special control (which will be described later). Control signals V1 to V4 output from the control signal generation circuit 30 are signals for causing the vertical charge transfer sections 13 of each column to transfer charges in the vertical direction. Also, control signals H1 to H4 output from the control signal generation circuit 30 are signals for causing the horizontal charge transfer section 20 to transfer charges in the horizontal direction.

The signal charges of the pixels output from the segment region 10a of the pixel sections 10 are sequentially input to the signal processing section 200 through the horizontal charge transfer section 20 and the output amplifier 41. Similarly, the signal charges of the pixels output from the segment region 10b are input to the signal processing section 200 through the horizontal charge transfer section 20 and the output amplifier 42. The signal charges of the pixels output from the segment region 10c are input to the signal processing section 200 through the horizontal charge transfer section 20 and the output amplifier 43. The signal charges of the pixels output from the segment region 10d are input to the signal processing section 200 through the horizontal charge transfer section 20 and the output amplifier 44.

As shown in FIG. 1, the low-frequency noises of the signals output from the output amplifier 41 are removed by the low-frequency removing portion 211 in the signal processing section 200. Then, the signals of the pixels are converted into digital signals by the analog/digital converting section 221, and the converted digital signals are input to the offset correction section 230. Similarly, the low-frequency noises of the signals output from the output amplifier 42 are removed by the low-frequency removing portion 212 in the signal processing section 200. Then, the signals of the pixels are converted into digital signals by the analog/digital converting section 222, and the converted digital signals are input to the offset correction section 230. The low-frequency noises of the signals output from the output amplifier 43 are removed by the low-frequency removing portion 213 in the signal processing section 200. Then, the signals of the pixels are converted into digital signals by the analog/digital converting section 223, and the converted digital signals are input to the offset correction section 230. The low-frequency noises of the signals output from the output amplifier 44 are removed by the low-frequency removing portion 214 in the signal processing section 200. Then, the signals of the pixels are converted into digital signals by the analog/digital converting section 224, and the converted digital signals are input to the offset correction section 230.

The offset correction section 230 processes the signals input from the A/D converting sections 221 to 224 on pixel basis to correct the offsets, and outputs the processed signals to the gain correction section 240. The gain correction section 240 processes the signals input from the offset correction section 230 on pixel basis to correct amplitudes of the signals (corresponding to gain correction), and outputs the processed signals to the image signal processing section 250. The image signal processing section 250 performs the same process as that of a general signal processing circuit such as a digital camera.

Next, the specific operations of the offset correction section 230 and the gain correction section 240 will be described.

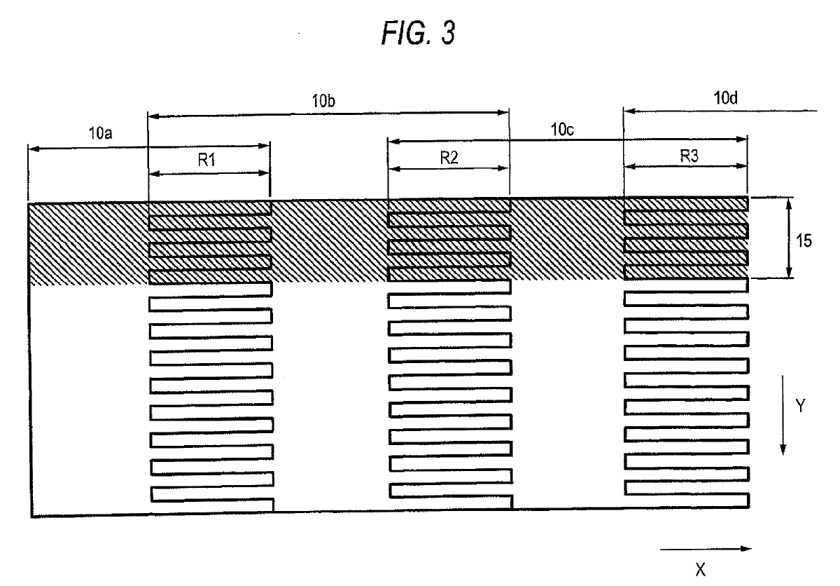

Hereinafter, as schematically shown in FIG. 3, it is assumed to process the signals of the pixels output from the pixel section 10, which is divided into the plurality of segment regions 10a, 10b, 10c, etc. As shown in FIG. 3, the boundary between the segment regions 10a and 10b, the boundary between the segment regions 10b and 10c, and the boundary between the segment regions 10c and 10d are formed in the zigzag manner.

For this reason, a range where the segment region 10a exists and a range where the segment region 10b exists partially overlap each other in the horizontal direction (arrow X direction), and an overlapping portion R1 is formed. That is, pixels of a column corresponding to the overlapping portion R1 belong to the segment region 10a or segment region 10b, depending on row positions. Similarly, the range where the segment region 10b exists and a range where the segment region 10c exists partially overlap each other in the horizontal direction, and an overlapping portion R2 is formed. In addition, the range where the segment region 10c exists and a range where the segment region 10d exists partially overlap with each other in the horizontal direction, and an overlapping portion R3 is formed. Each width of the overlapping portions R1 to R3 in the horizontal direction may be one column (width corresponding to one pixel), or may be two or more columns. In other words, the pixel section 10 are divided along one direction into plural regions to define the segment regions 10a, 10b, 10c, and 10d, and the segment regions 10a, 10b, 10c, and 10d are formed so that the segment regions 10a, 10b, 10c, and 10d at least partially overlap each other along a direction perpendicular to the one direction. The overlapping portions become the plurality of overlapping portions R1, R2, and R3, respectively.

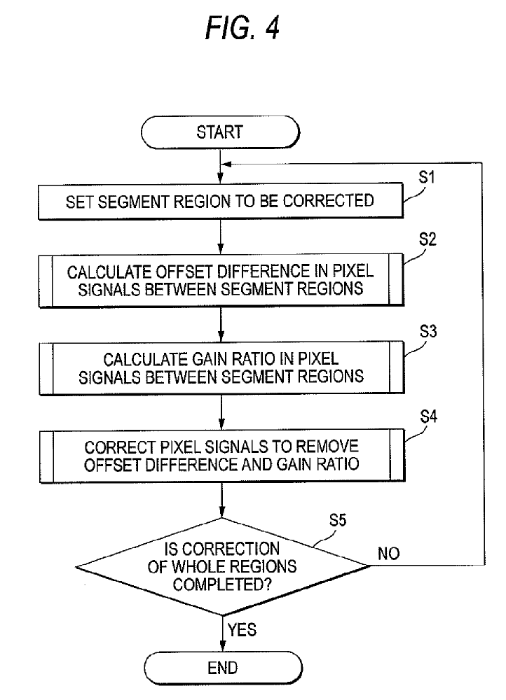

FIG. 4 is a flowchart illustrating main procedures of the offset correction process and the gain correction process.

First, two segment regions are extracted from the plurality of segment regions in a captured image (S1). For example, two segment regions are sequentially extracted from an end portion thereof. Then, an offset difference in an overlapping portion between the two segment regions is calculated (S2), and a gain ratio in the overlapping portion is calculated (S3). Then, the pixel signals are corrected to remove the offset difference and the gain ratio in the overlapping portion (S4). These steps are performed for all segment regions.

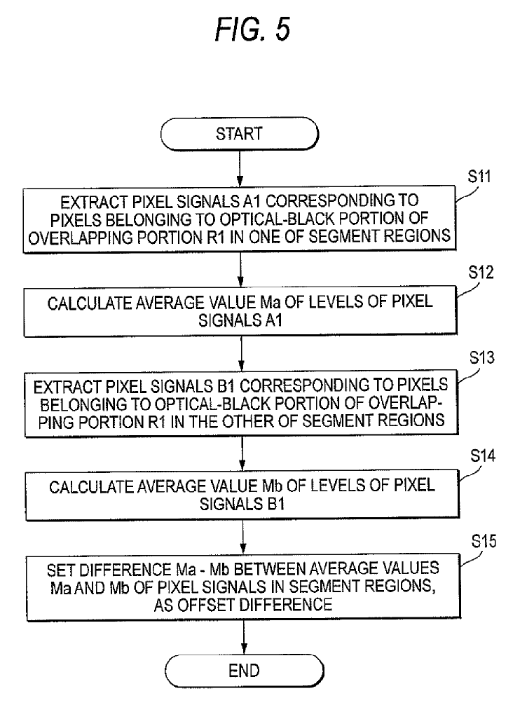

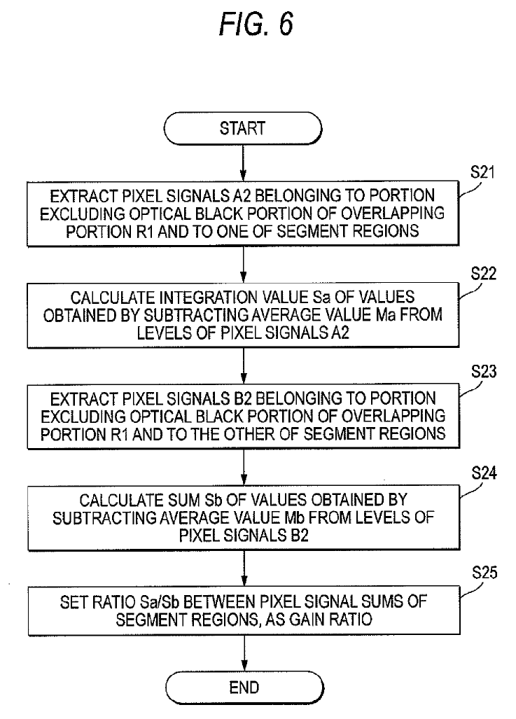

FIG. 5 shows specific procedures for calculating the offset difference, and FIG. 6 shows specific procedures for calculating the gain ratio.

The offset correction section 230 detects the offset difference in pixel signals between the segment region 10a and the segment region 10b in accordance with the flowchart shown in FIG. 5.

First, pixel signals (A1) corresponding to a plurality of pixels belonging to the overlapping portion R1 and to an OB portion (optical black region) 15 are extracted from the segment region 10a (S11). In the OB portion 15, extraneous light is restricted to be incident thereon. For example, photoelectric conversion elements in the OB portion are light-shielded photoelectric conversion elements or dummy photoelectric conversion elements not existing actually. Then, an average value (Ma) of the levels of the plurality of pixel signals (A1) extracted in Step S11 is calculated (S12). Next, pixel signals (B1) corresponding to a plurality of pixels belonging to the overlapping portion R1 and to the OB portion (optical black region) 15 are extracted from the segment region 10b (S13). An average value (Mb) of the levels of the plurality of pixel signals (B1) extracted in Step S13 is calculated (S14). A difference value (Ma−Mb) between the average values of the segment regions 10a and 10b is calculated as an offset difference (S15).

In order to remove the thus-obtained offset difference in the overlapping portion between the segment region 10a and the segment region 10b (that is, to make the difference value (Ma−Mb) between the average values be substantially equal to zero), the offset correction section 230 corrects the levels of the pixel signals input from at least one of the adjacent segment regions. The offset between the segment region 10b and the segment region 10c and the offset between the segment region 10c and the segment region 10d are processed in the same manner.

Meanwhile, the gain correction section 240 detects the gain ratio (amplitude difference) in the pixel signals between the segment region 10a and the segment region 10b in accordance with the flowchart shown in FIG. 6.

First, pixel signals (A2) corresponding to a plurality of pixels belonging to the overlapping portion R1 and to portions excluding the OB portion 15 are extracted from the segment region 10a (S21). An integration value (Sa) of values obtained by subtracting the average value Ma from the levels of the plurality of pixel signals (A2) extracted in step S21 is calculated (S22). Pixel signals (B2) of a plurality of pixels belonging to the overlapping portion R1 and to the portions excluding the OB portion 15 are extracted from the segment region 10b (S23). An integration value (Sb) of values obtained by the subtracting average value Mb from the levels of the plurality of pixel signals extracted in step S23 is calculated (S24). A ratio (Sa/Sb) of the integration values between the segment regions is calculated as a gain ratio (S25). Herein, an integration process means a process of sequentially summing up the plurality of pixel signals.

In order to remove the gain ratio in the overlapping portion between the segment region 10a and the segment region 10b obtained as described above (that is, to make the ratio (Sa/Sb) of the integration values subsequently equal to 1), the gain correction section 240 corrects the pixel signals input from at least one of the adjacent segment regions. The gain ratio between the segment region 10b and the segment region 10c and the gain ratio between the segment region 10c and the segment region 10d are processed in the same manner.

When the solid-state imaging device is a color imaging device that outputs pixel signals separated into color components of R (red), G (green), and B (blue), it is preferable to select only G color as the plurality of pixels extracted by the offset correction section 230 in steps S11 and S13 and the plurality of pixels extracted by the gain correction section 240 in steps S21 and S23. Thereby, since pixel signals having a relatively large amount of received light are used, the correction process is insusceptible to an influence of a difference in wavelength of light. Therefore, it is possible to perform more accurate correction.

Next, a more specific configuration and operation to form a boundary in a zigzag manner as shown in FIGS. 2 and 3 will be described.

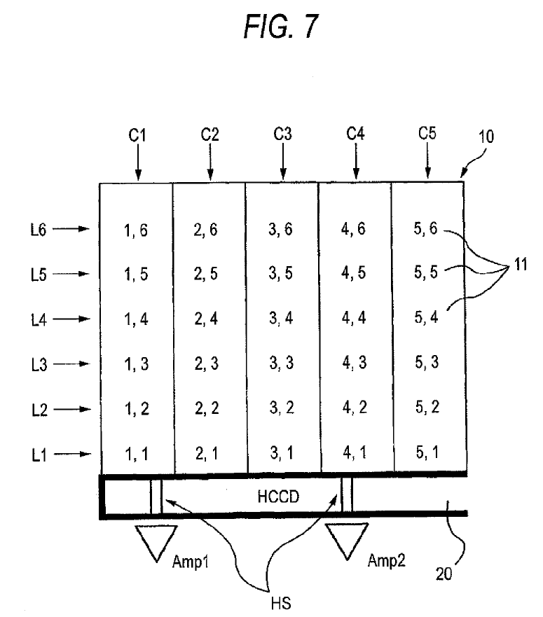

In the example shown in FIG. 1, it is assumed that the pixel section 10 is divided into the plurality of segment regions 10a, 10b, 10c, and 10d at intervals of five columns of the imaging cells 11, and that the signals of each segment region are output from the independent output amplifiers 41 to 44 through the output branch sections 21 to 24, which are provided independently for the respective segment regions. However, in this example, a solid-state imaging device having the configuration shown in FIG. 7 will be described for the purpose of simplifying the description. In the solid-state imaging device shown in FIG. 7, arranged columns of the imaging cells 11 are denoted by C1 to C5, and arranged rows of the imaging cells 11 are denoted by L1 to L6. In FIG. 7, the column numbers and the row numbers are indicated in the respective imaging cells 11 in order to distinguish signal charges of the pixel cells 11 from each other.

That is, in the solid-state imaging device shown in FIG. 7, the pixel section 10 is divided into the segment regions at intervals of two columns of the imaging cells 11. The signals are output from independent output amplifiers Amp1, Amp2, . . . that are provided every two columns. Although this point is different from the configuration of the solid-state imaging device shown in FIG. 1, there is no other difference in the basic configuration.

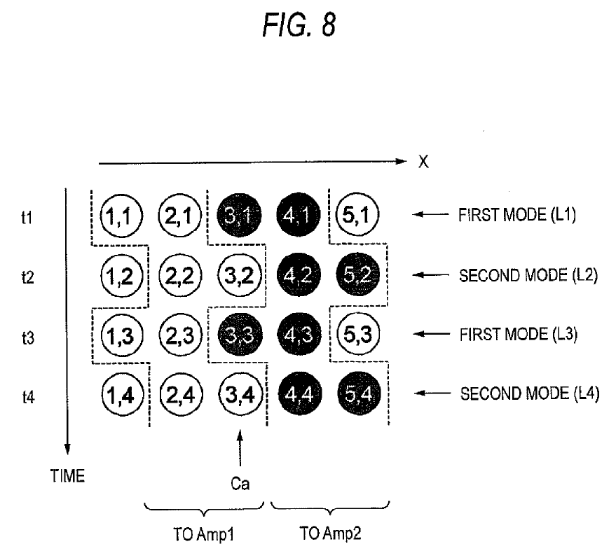

FIG. 8 shows a specific control example in the case of reading out the signal charges from the solid-state imaging device having the configuration shown in FIG. 7. In this control example, it is assumed that the signal charges of the row L1 shown in FIG. 7 are read out at a time t1, the signal charges of the row L2 are read out at a time t2, the signal charges of the row L3 are read out at a time t3, and the signal charges of the row L4 are read out at a time t4.

A detailed control of reading out the signal charges will be described later. At the time t1, a reading control is performed in a “first mode.” At the time t2, a reading control is performed in a “second mode.” At the time t3, a reading control is performed in the “first mode.” At the time t4, a reading control is performed in the “second mode”. That is, the difference reading modes of the “first mode” and the “second mode” are alternately repeated every one row.

In FIG. 8, the pixel positions of the signal charges are denoted by the column numbers and the row numbers corresponding to the signal charges in the imaging cells 11 shown in FIG. 7. As shown in FIG. 8, when the signal charges of the first row (L1) are read out at the time t1, the signal charges of the first and second columns (C1, C2) are output to the output amplifier Amp1 and the signal charges of the third and fourth columns (C3, C4) are output to the output amplifier Amp2.

Similarly, when the signal charges of the second row (L2) are read out at the time t2, the signal charges of the second and third columns (C2, C3) are output to the output amplifier Amp1 and the signal charges of the fourth and fifth columns (C4, C5) are output to the output amplifier Amp2. When the signal charges of the third row (L3) are read out at the time t3, the signal charges of the first and second columns (C1, C2) are output to the output amplifier Amp1 and the signal charges of the third and fourth columns (C3, C4) are output to the output amplifier Amp2. When the signal charges of the fourth row (L4) are read out at the time t4, the signal charges of the second and third columns (C2, C3) are output to the output amplifier Amp1 and the signal charges of the fourth and fifth columns (C4, C5) are output to the output amplifier Amp2.

Accordingly, with regard to the signal charges of the column Ca shown in FIG. 8, the signal charges in even lows are output to the output amplifier Amp1, and the signal charges in odd rows are output to the output amplifier Amp2. Therefore, a boundary between a segment region including signal charges output to the output amplifier Amp1 and a segment region including signal charges output to the output amplifier Amp2 is formed to shift one column for each one row. Thus, the boundary is formed in the zigzag manner.

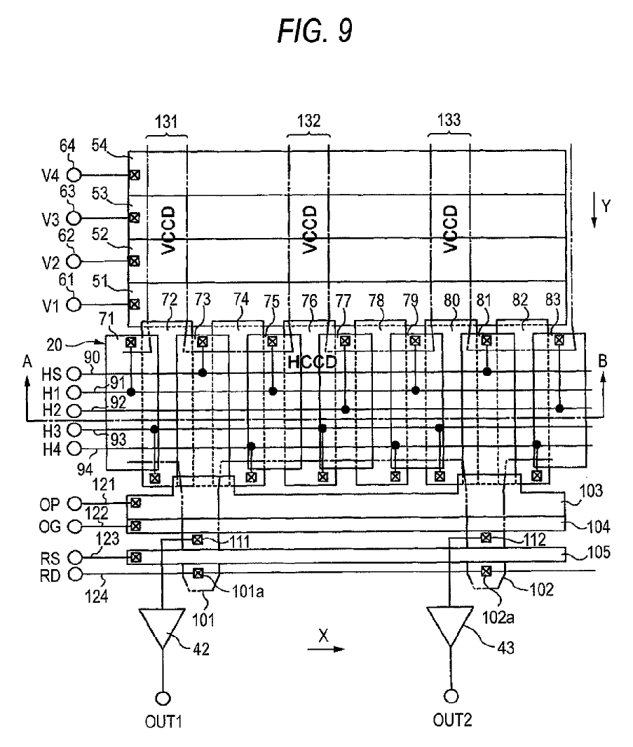

FIG. 9 shows a specific example of the detailed configuration in the vicinity of the horizontal charge transfer section in the solid-state imaging device shown in FIG. 7.

Three vertical charge transfer sections 131, 132, and 133 shown in FIG. 9 correspond to the vertical charge transfer sections 13 in FIG. 1. That is, FIG. 9 shows the configuration to read out the signal charges from the imaging cells 11 of the three columns.

In FIG. 9, vertical transfer electrodes 51, 52, 53, and 54 are formed at positions opposed to the respective vertical charge transfer sections 131, 132, 133. The vertical transfer electrodes 51, 52, 53, and 54 are used to form a potential distribution for sequentially transferring the signal charges in the arrow Y-direction, on channels of the vertical charge transfer sections 131, 132, and 133.

Control signals V1, V2, V3, and V4 are applied to terminals 61, 62, 63, and 64 connected to the vertical transfer electrodes 51, 52, 53, and 54, respectively.

The horizontal charge transfer section 20 is formed at a position adjacent to an end portion on a downstream side (arrow Y direction side) of the vertical charge transfer sections 131, 132, and 133 in the charge transfer direction. Horizontal transfer electrodes 71 to 83, etc. are formed at positions opposed to the horizontal charge transfer section 20. FIG. 9 only shows a part of them. The horizontal transfer electrode 71 to 83, etc. are used to form a potential distribution for sequentially transferring the signal charges in the arrow X direction and an opposite direction thereto, on channels of the horizontal charge transfer section 20.

Control signals Hs, H1, H2, H3, and H4 for horizontal transfer are applied to the horizontal transfer electrodes 71 to 83, etc. through signal lines 90, 91, 92, 93, and 94, respectively.

In the solid-state imaging device 10 according to this embodiment of the invention, the horizontal charge transfer section 20 has the following configuration.

As shown in FIG. 9, output branch sections 101 and 102 are formed so as to protrude from a part of the channel of the horizontal charge transfer section 20 toward a side direction (Y direction). The output branch sections 101 and 102 corresponds to the output branch sections 21 to 24 shown in FIG. 1, and are provided to branch and output the signal charges from a midway portion of the channel of the horizontal charge transfer section 20. The output branch sections 101 and 102 are provided with floating diffusions (FD) 111 and 112. The signal charges on the output branch section 101 are input to the output amplifier 42 through the FD 111, and the signal charges on the output branch section 102 are input to the output amplifier 43 through the FD 112.

Also, the plurality of horizontal transfer electrodes 71 to 83, etc. for controlling the horizontal charge transfer section 20 are connected to the signal lines 91 to 94 so that four-phase control signals H1, H3, H2, and H4 are sequentially applied in accordance with the arrangement order in the arrow X direction. The electrodes 73 and 81 opposed to the output branch sections 101 and 102 are connected to the signal line 90 so that the control signal Hs is applied thereto instead of the control signal H2.

Control electrodes 103 and 104 are provided to control movement of the signal charges between the channel of the horizontal charge transfer section 20 and the output branch sections 101 and 102. A control signal OP is applied to the control electrode 103 through a signal line 121, and a control signal OG is applied to the control electrode 104 through a signal line 122.

An electrode 101a that forms a reset drain RD is formed at an end portion of the output branch section 101. An electrode 102a that forms the reset drain RD is also formed at an end portion of the output branch section 102 in the same manner. The electrodes 101a and 102a are connected to a signal line 124. A control electrode 105 is formed at a position between the FD 111 and the electrode 101a and a position between the FD 112 and the electrode 102a. A control signal (reset signal) RS is applied to the control electrode 105 through a signal line 123.

Next, described will be a specific control method for forming the boundary between the segment regions in the zigzag manner shown in FIG. 8 by using the solid-state imaging device 10 having the configuration shown in FIG. 9.

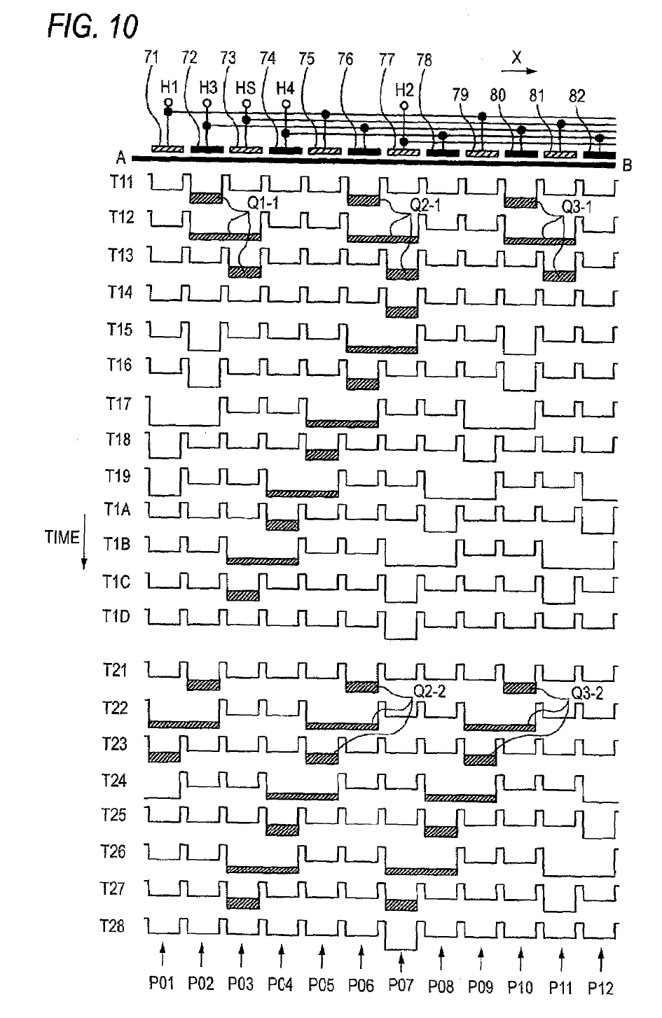

FIG. 10 is a time chart illustrating a specific example of change in positions of signal charges in the horizontal charge transfer section shown in FIG. 9.

Schematically, during a period between time T11 and time T1D shown in FIG. 10, driving in the “first mode” is performed so that (i) signal charges Q1-1 and Q2-1 transferred from the vertical charge transfer sections 131 and 132 to the channels of the horizontal transfer electrodes 72 and 76 are transferred to the output amplifier 42 and (ii) signal charges Q3-1 transferred from the vertical charge transfer section 133 to the channel of the horizontal transfer electrode 80 are transferred to the output amplifier 43. Also, during a period between time T21 and time T2D (although time 29 to time 2D are not shown in FIG. 10), driving in the “second mode” is performed so that signal charges Q2-2 and Q3-2 transferred from the vertical charge transfer sections 132 and 133 to the channels of the horizontal transfer electrodes 76 and 80 are transferred to the output amplifier 42.

Also, during a period between the time T1 and the time T13 (in the first mode), the signal charges Q1-1, Q2-1, and Q3-1 are transferred in a direction (from the left side to the right side in FIG. 10) opposite to a forward direction, and the signal charges Q1-1 and Q3-1 are output from the output terminals OUT1 and OUT2, respectively. During a period between the time T14 and the time T1D, the signal charges Q2-1 are transferred in the forward direction (from the right side to the left side in FIG. 10), and are output from the output terminal OUT1.

In a reading control of the “first mode”, at the time T11, the signal charges Q1-1 (see FIG. 10) of one pixel transferred from the vertical charge transfer section 131 shown in FIG. 9 move onto the channel of the horizontal charge transfer section 20 just under the horizontal transfer electrode 72. Similarly, the signal charges Q2-1 of one pixel transferred from the vertical charge transfer section 132 move onto the channel just under the horizontal transfer electrode 76, and the signal charges Q3-1 of one pixel transferred from the vertical charge transfer section 133 move onto the channel just under the horizontal transfer electrode 80.

During the period between the time T11 and the time T13, by controlling the control signals HS and H1 to H4, the signal charges Q1-1 move on the horizontal charge transfer section 20 toward the right side in FIG. 10 from the position just under the horizontal transfer electrode 72 to a position P03 just under the horizontal transfer electrode 73 as shown in FIG. 10. Similarly, the signal charges Q2-1 move toward the right side in FIG. 10 from a position just under the horizontal transfer electrode 76 to a position P07 just under the horizontal transfer electrode 77. Also, the signal charges Q3-1 move toward the right side in FIG. 10 from a position just under the horizontal transfer electrode 80 to a position P11 just under the horizontal transfer electrode 81.

At the time T13, when the control signal HS is set to a high level (H), potential pockets are formed just under the horizontal transfer electrodes 73 and 81, and the signal charges are retained in the potential pockets. When the control signal OP is set to a low level (L), the signal charges Q1-1 and Q3-1 don't move from the position just under the horizontal transfer electrodes 73 and 81 to the output branch sections 101 and 102 due to a formed potential barrier. In this case, the signal charges are transferred only in the horizontal direction (Y-direction) in the same manner as the general HCCD.

When the control signal OP is set to the high level (H: a potential higher than that of the control signal HS) at the time T3, the signal charges Q1-1 just under the horizontal transfer electrode 73 move to the output branch section 101 in accordance with a potential slope formed between the position just under the horizontal transfer electrode 73 and the output branch section 101. Similarly, the signal charges Q3-1 just under the horizontal transfer electrode 81 move to the output branch section 102 in accordance with a potential slope formed between the position just under the horizontal transfer electrode 81 and the output branch section 102.

Signal charges that flow into the FDs 111, 112 in a previous time may remain in the regions (capacitor) of the FDs 111, 112 formed in the output branch sections 101 and 102. However, when the control signal RS is set to the high level (H) at the time T12, a potential barrier between the FD 111 and the electrode 101a and a potential barrier between the FD 112 and the electrode 102a disappear. Accordingly, the charges in the FD 111 flow to the electrode 101a and the charges in the FD 112 flow to the electrode 102a, and then the signal charges are discarded into the reset drain RD. Therefore, before new signal charges flow in after the time T13, the charges in the FDs 111 and 112 are initialized (reset).

When the reset is completed and the control signal RS is returned to the low level (L) after the time T12, the potential barriers are formed again between the FD 111 and the electrode 101a and between the FD 112 and the electrode 102a. Accordingly, the signal charges do not move between the FDs 111 and 112 and the reset drain RD.

Consequently, in the “first mode”, the signal charges Q1-1 transferred from the vertical charge transfer section 131 pass through the horizontal charge transfer section 20, move to the output branch section 101 at the time T14, are transferred to the FD 111, and are output from the output amplifier 42 to the output terminal OUT1 as a voltage corresponding to a charge amount of the signal charges. Also, the signal charges Q3-1 transferred from the vertical charge transfer section 133 pass through the horizontal charge transfer section 20, move to the output branch section 102 at the time T14, are transferred to the FD 112, and output from the output amplifier 43 to the output terminal OUT2 as a voltage corresponding to a charge amount of the signal charges.

During the period between the time T11 and the time T13, the signal charges Q2-1 transferred from the vertical charge transfer section 132 are transferred in the right direction in FIG. 10 on the horizontal charge transfer section 20 in the same manner as the other signal charges Q1-1 and Q3-1. However, the signal charges Q2-1 remain on the horizontal charge transfer section 20 even after the time T14. Then, after the time T14, the signal charges Q2-1 are sequentially transferred from the position just under the horizontal transfer electrode 77 in the left direction (the direction opposite to the arrow X direction) in FIG. 10, in accordance with the control signals H1 to H4 and Hs applied to the horizontal transfer electrodes 73 to 77. Eventually, the signal charges Q2-1 reach the position just under the horizontal transfer electrode 73 at the time TIC.

Since the output branch section 101 is formed at the position of the horizontal transfer electrode 73, the signal charges Q2-1 existing just under the horizontal transfer electrode 73 at the time TIC move to the output branch section 101 and therefore, can be read out from the output amplifier 42 in the same manner as reading out of the signal charges Q1-1. That is, when the control signal OP is set to the high level (H: the potential higher than that of the control signal HS) at the time T1D, the signal charges Q2-1 just under the horizontal transfer electrode 73 move to the output branch section 101 in accordance with the potential slope formed between the position just under the horizontal transfer electrode 73 and the output branch section 101.

Consequently, in the “first mode”, the signal charges Q2-1 output from the vertical charge transfer section 132 pass through the horizontal charge transfer section 20, move to the output branch section 101 at the time T1D, are transferred to the FD 111, and are output from the output amplifier 42 to the output terminal OUT1 as a voltage corresponding to the charge amount of the signal charges.

Meanwhile, in the “second mode”, the signal charges on the horizontal charge transfer section 20 are sequentially transferred only in the left direction in FIG. 10, as apparent from figures on and after the time T21 shown in FIG. 10.

That is, the signal charges Q2-2 (see FIG. 10) transferred from the vertical charge transfer section 132 shown in FIG. 9 are accumulated in the position just under the horizontal transfer electrode 76 at the time T21, are sequentially transferred toward the left side in accordance with the control signals H1 to H4 and HS applied to the horizontal transfer electrodes 73 to 76 on and after the time 22, and reach the position just under the horizontal transfer electrode 73 at the time T27.

At the position of the horizontal transfer electrode 73, since the output branch section 101 is formed at the position adjacent to the horizontal charge transfer section 20, the signal charges Q2-2 existing just under the horizontal transfer electrode 73 at the time T27 move to the output branch section 101 and therefore, can be read out from the output amplifier 42. That is, when the control signal OP is set to the high level (H: the potential higher than that of the control signal HS) at the time T28, the signal charges Q2-2 just under the horizontal transfer electrode 73 move to the output branch section 101 in accordance with the potential slope formed between the position just under the horizontal transfer electrode 73 and the output branch section 101. Consequently, in the “second mode”, the signal charges Q2-2 output from the vertical charge transfer section 132 pass through the horizontal charge transfer section 20, move to the output branch section 101 at the time T28, are transferred to the FD 111, and are output from the output amplifier 42 to the output terminal OUT1 as voltage signals corresponding to the charge amount of the signal charges.

The signal charges Q3-2 output from the vertical charge transfer section 133 are accumulated in the position just under the horizontal transfer electrode 80 as shown in FIG. 10 at the time T21, are sequentially transferred toward the left side in FIG. 10 in accordance with the control signals H1 to H4 and HS applied to the horizontal transfer electrodes 77 to 80 on and after the time 22, and reach the position just under the horizontal transfer electrode 77 at the time T27. In this case, since no output branch section is provided at a position adjacent to this position, the signal charges Q3-2 may remain on the horizontal charge transfer section 20 even after the time T28. Although not shown in FIG. 10, the signal charges Q3-3 are moved to the position just under the horizontal transfer electrode 73 by continuously transferring the signal charges Q3-3 again on the horizontal charge transfer section 20 toward the left side in FIG. 10 on and after T28. Therefore, in the “second mode”, the signal charges Q3-2 output from the vertical charge transfer section 133 also pass through the horizontal charge transfer section 20, move to the output branch section 101 after the time T28, are transferred to the FD 111, and are output from the output amplifier 42 to the output terminal OUT1 as voltage signals corresponding to the charge amount of the signal charges.

That is, in the “first mode”, the signals (corresponding to (2, 1) in FIG. 8) corresponding to the signal charges Q2-1 are output from the output amplifier 42, and the signals (corresponding to (3, 1) in FIG. 8) corresponding to the signal charges Q3-1 are output from the output amplifier 43. On the contrary, in the “second mode”, both of the signals (corresponding to (2, 2) and (3, 2)) corresponding to the signal charges Q2-2 and the signal charges Q3-2 are output from the output amplifier 42. Accordingly, in the “first mode”, the position between the column of the vertical charge transfer section 132 for outputting the signal charges Q2-1 and the column of the vertical charge transfer section 133 for outputting the signal charges Q3-1 becomes the boundary position between the segment regions. On the contrary, in the “second mode”, the position on the right side of the column of the vertical charge transfer section 133 for outputting the signal charges Q3-2 becomes the boundary position between the segment regions.

Accordingly, when the reading operation of the “first mode” and the reading operation of the “second mode” are controlled to be repeated alternately every row, the column serving as the boundary position alternately shifts between the right side and the left side every row, as shown in FIG. 8. Therefore, it is possible to form the boundary in the zigzag manner.

The configurations and operations according to the above embodiment described above may be variously modified. Specific example of modifications will be described below:

(1) In the control example shown in FIG. 10, the “first mode” and the “second mode” are switched every row. However, the “first mode” and the “second mode” may be switched every two or more rows. With this configuration, it is possible to adjust a width between a peak and a valley in the zigzag shape in the boundaries between the segment regions. Thus, it is possible to adjust the boundaries to be more inconspicuous under the visual characteristics of the human eyes.

(2) In the control example shown in FIG. 10, the boundary positions are controlled to shift one column in the right and left direction due to the switch between the “first mode” and the “second mode.” However, the boundary positions may be controlled to shift plural columns. With this configuration, it is possible to adjust the height between the peak and the valley of the zigzag shape in the boundaries between the segment regions. Thus, it is possible to adjust the boundaries to be more inconspicuous under the visual characteristics of the human eyes.

(3) In the control example shown in FIG. 10, it is assumed that the signal charges are transferred in the two directions of the right direction and the left direction in the “first mode” and that the signal charges are transferred only in the left direction in the “second mode.” However, if such a relation can be maintained that the boundary positions shift due to the difference in controls of the “first mode” and the “second mode,” the signal charges may be transferred in the two directions also in the “second mode.” In addition, the signal charges may be transferred in the left direction and then transferred in the right direction.

Moreover, the number of segment regions into which the pixel section is divided and a method of dividing the pixel section into the segment regions may be variously modified, and may be set to be appropriately optimized.

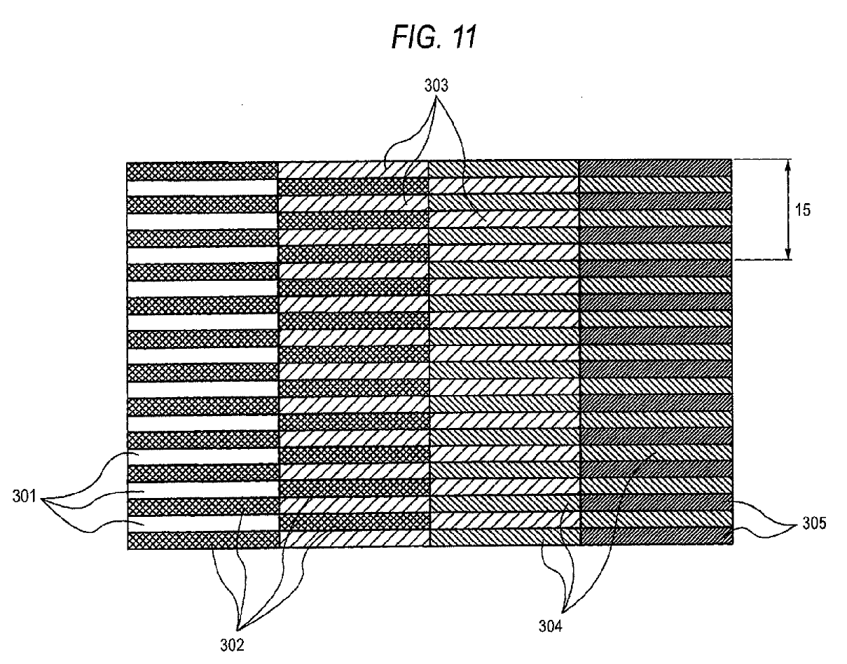

In consideration of the modified examples, the method of dividing the pixel section 10 of the solid-state imaging device may be one shown in FIG. 11. In the configuration example shown in FIG. 11, a plurality of rectangular segment regions 301 to 305 are arranged in mosaic patterns. In this case, the signal charges obtained from the segment regions 301 to 305 are output from output amplifiers that are provided independently from each other via independent paths, respectively.

When the offset correction section 230 and the gain correction section 240 perform the signal process for the solid-state imaging device having the configuration shown in FIG. 11, the signal process may be performed in the same manner as described above. When the process of adjusting the offset differences and the gain ratios from one end of the pixel section 10 with respect to the overlapping portions between the segment regions is sequentially performed toward the other end, correction coefficients for the segment region at the one end which is first adjusted and for the segment region adjacent thereto become a reference for adjusting the next segment region. Since the offset differences and the gain ratios are removed by repeating this process, it is possible to reduce the deterioration in the image quality due to the division of the pixel section.

As described above, the solid-state imaging apparatus and the signal processing method according to the embodiments of the invention may be applicable to CCD-type two-dimensional image sensors. Therefore, when the pixel section is divided into the plurality of segment regions to enable the high-speed signal reading, it is possible to prevent the boundaries between the segment regions from being conspicuous. Thus, it is possible to prevent the deterioration in the image quality. Particularly, since it is not necessary to perform the redundant reading of signals at the same pixel position or to perform a plurality of exposure steps, it is possible to accurately correct the offset differences and the gain ratios between the segment regions. Accordingly, even when the boundaries are formed in the zigzag manner, it is possible to prevent deterioration in resolution.

What is claimed is:

1. A solid-state imaging apparatus comprising:
a solid-state imaging device that includes
a pixel section having a plurality of two-dimensionally arranged photoelectric conversion elements that generate signal charges in accordance with incident light, and
a charge transfer section that receives the signal charges from the pixel section and transfers the received signal charges in a predetermined direction; and
a signal processing section that converts the signal charges output from the solid-state imaging device into pixel signals to generate image data, wherein:
the pixel section is divided, along one direction, into a plurality of segment regions,
the signal processing section obtains the signal charges generated in the respective segment regions from different positions in the charge transfer section through different output sections and converts the obtained signal charges into the image data in accordance with predetermined conversion conditions,
the plurality of segment regions are formed so that the segment regions at least partially overlap each other along a direction perpendicular to the one direction, and
the signal processing section has a function of correcting the pixel signals, the function that compares the pixel signals of a plurality of overlapping portions where the segment regions overlap each other and makes the conversion conditions for the respective segment regions equivalent to each other.

2. The solid-state imaging apparatus according to claim 1, wherein the signal processing section corrects the pixel signals so that
(i) an offset difference in each overlapping portion, which is caused when the signal charges output from each overlapping portion between the corresponding segment regions are converted into the pixel signals, is substantially equal to zero, and
(ii) a gain ratio in each overlapping portion, which is caused when the signal charges output from each overlapping portion between the corresponding segment regions are converted into the pixel signals, are substantially equal to 1.

3. The solid-state imaging apparatus according to claim 2, wherein each offset difference is a value based on a difference between (i) a first average value of the pixel signals of the whole overlapping portion of one of the segment regions within an optical black region where extraneous light is restricted to be incident and (ii) a second average value of the pixel signals of the whole overlapping portion of another of the segment regions.

4. The solid-state imaging apparatus according to claim 2, wherein each gain ratio is a value based on a ratio of (i) a first integration value of the pixel signals of the whole overlapping portion of one of the segment regions to (ii) a second integration value of the pixel signals of the whole overlapping portion of another of the segment regions.

5. The solid-state imaging apparatus according to claim 3, wherein each gain ratio is a value based on a ratio of (i) a first integration value of the pixel signals of the whole overlapping portion of the one of the segment regions to (ii) a second integration value of the pixel signals of the whole overlapping portion of the other of the segment regions.

6. The solid-state imaging apparatus according to claim 1, wherein the pixel section is divided into the segment regions so as to periodically form the overlapping portions between the segment regions.

7. The solid-state imaging apparatus according to claim 2, wherein the pixel section is divided into the segment regions so as to periodically form the overlapping portions between the segment regions.

8. The solid-state imaging apparatus according to claim 3, wherein the pixel section is divided into the segment regions so as to periodically form the overlapping portions between the segment regions.

9. The solid-state imaging apparatus according to claim 4, wherein the pixel section is divided into the segment regions so as to periodically form the overlapping portions between the segment regions.

10. The solid-state imaging apparatus according to claim 5, wherein the pixel section is divided into the segment regions so as to periodically form the overlapping portions between the segment regions.

11. A signal processing method for use in a solid-state imaging apparatus, wherein
the solid-state imaging apparatus includes a solid-state imaging device that includes
a pixel section having a plurality of two-dimensionally arranged photoelectric conversion elements that generate signal charges in accordance with incident light, and
a charge transfer section that receives the signal charges from the pixel
section and transfers the received signal charges in a predetermined direction,
the pixel section is divided, along one direction, into a plurality of segment regions, and the plurality of segment regions are formed so that the segment regions at least partially overlap each other along a direction perpendicular to the one direction,
the signal processing method comprising:
obtaining the signal charges generated in the respective segment regions from different positions in the charge transfer section through different output sections;
converting the signal charges obtained from the solid-state imaging device into pixel signals;
comparing the pixel signals of a plurality of overlapping portions where the segment regions overlap each other; and
correcting the pixel signals of the respective segment regions so that
(i) an offset difference in each overlapping portion, which is caused when the signal charges output from each overlapping portion between the corresponding segment regions are converted into the pixel signals, is substantially equal to zero, and
(ii) a gain ratio in each overlapping portion, which is caused when the signal charges output from each overlapping portion between the corresponding segment regions are converted into the pixel signals, are substantially equal to 1.
